(19) United States
(12) Patent Application Publication
(10) Pub. No.: US 2002/0136529 A1
(43) Pub. Date: Sep. 26, 2002

(54) Caption subject matter creating system, caption subject matter creating method and a recording medium in which caption subject matter creating program is stored

(76) Inventors: Yuji Yamashita, Osaka (JP); Toru Koguma, Tokyo (JP)

Correspondence Address: David A. Blumenthal, FOLEY & LARDNER, Washington Harbour, 3000 K Street, N.W., Suite 500, Washington, DC, 20007-5109, US

(21) Appl. No.: 09/729,670

(22) Filed: Mar. 22, 2001

(51) Int. Cl. H04N 5/92; G11B 27/00; G09G 5/00

(52) U.S. Cl. 386/52; 386/65; 345/723

(57) ABSTRACT

Video and voice from a video device 5 are taken in a computer 1. The video and voice taken in the computer are converted into digital data, and become to be a file in which a video data and a voice data are associated with each other for every frame, and after a frame number for discriminating each frame is allocated thereto, the data are stored in a hard disk 12. A frame that will be a SHOW point is designated, and a number of this frame is acquired. Subsequently, an IN point frame and an OUT point frame are set, and frame numbers corresponding thereto are acquired. Video and voice between the IN point and the OUT point are reproduced, and a text is input while the voice is heard. After completion of the input, a time code of the IN point and a time code of the OUT point are calculated based on a frame number of the SHOW point, a frame number of the IN point and a frame number of the OUT point, and a set of the time code of the IN point, the time code of the OUT point and a text data are stored as a data.

### BACKGROUND OF THE INVENTION

The present invention relates to a technology of caption subject matter creation, and more particularly to a caption subject matter creating system, a caption subject matter creating method and a recording medium in which a caption subject matter program is stored, for obtaining a time code necessary for conducting caption broadcasting and a closed caption and a text data synchronous with the time code.

For conducting caption broadcasting and a closed caption, a text data synchronous with voice of a program is needed. Usually, a caption subject matter corresponding to a broadcasting format of caption broadcasting is created from time codes of a VTR of a broadcasting subject matter and a text data corresponding to voice therebetween.

Conventionally, for creating the caption broadcasting subject matter, a VTR tape of a broadcasting subject matter or a VHS tape in which a time code is displayed on a screen by dubbing it are needed, and if there is a script, that is further better for shortening a creation time period.

Here, a method that is conventionally implemented for obtaining a text data synchronous with a program voice will be explained below.

First, a rough text data is prepared by means of a script. The reason thereof is because there are actual circumstances that, since a schedule from completion of a newly produced program to its broadcasting is tight, in case that words are picked up from voice of a VTR, that is too late for the broadcasting.

Subsequently, synchronization between the prepared text data and the voice of the VTR are conducted while a time code is obtained by means of an operation of a jog and so forth of the VTR. Also, words different from a script by means of an ad lib and so forth are corrected. And, the obtained time code and the prepared text data are converted into a caption broadcasting format.

By the way, for creating the caption by means of the above-mentioned prior art, in case of a thirty-minute program, it is necessary to deliver a script one week to 10 days earlier, and to deliver a VTR tape three days to one week earlier.

In this manner, although the conventional work for caption production requires much time and lots of steps, the main cause thereof is that, in the prior art, in the middle of the program, it is impossible to synchronize picture voice and a caption produced individually on the same time axis. In other words, with regard to correction of a caption sending frame and a caption deleting frame or correction of a display position of a caption, there is no means other than a method in which inconsistent parts and inconsistent reasons are listed up through a whole program during a preview, and based on the list, the correction is collectively applied by almost depending on intuition, and the correction is extremely complicated and insufficient in the sense that, also in checking condition after the correction, synchronization with a caption must be conducted at a head of a program and a preview must be conducted through a whole program.

### SUMMARY OF THE INVENTION

The objective of the present invention is to solve the above-described tasks.

Moreover, the objective of the present invention is provide a caption subject matter creating system, a caption subject matter creating method and a storage medium in which a caption subject matter program is stored, capable of simply and efficiently creating a caption subject matter.

The above-described objective of the present invention is accomplished by a caption subject matter creating system comprising:

a memory for storing a digital data of an image and video;

a means for converting an image and voice recorded in a video tape into a digital data and storing the digital data in the above-described memory, and allocating frame numbers to each of frames;

a display for displaying an image based on the digital data stored in the above-described memory;

a voice outputting means for outputting voice based on the digital data stored in the above-described memory;

a means for setting a frame that will be a beginning frame of a time code out of the above-described frames, and storing a frame number of the above-described frame;

a means for setting a starting frame that will be a starting point of a frame in which voice is to be textured and a terminal frame that will be a terminal point, and storing a frame number of the set starting frame and a frame number of the terminal number;

a means for displaying and outputting video and voice of a frame between the frame number of the starting frame and the frame number of the terminal frame on the above-described display and the above-described voice outputting means;

a means for, based on voice output from the above-described voice outputting means, inputting a text data corresponding to the above-described voice;

a calculator for calculating a time code of the above-described starting frame based on the frame number of the above-described starting frame and the frame number of the above-described beginning frame;

a calculator for calculating a time code of the above-described terminal frame based on the frame number of the above-described terminal frame and the frame number of the above-described beginning frame; and

a memory for storing the above-described input text data, the time code of the above-described starting frame and the time code of the above-described terminal frame in association with each other.

In addition, it is considered that a letter inputting means is a key board or a voice recognition system.

Also, if a repeat means for repeatedly displaying and outputting video and voice of a frame between the frame number of the starting frame and the frame number of the terminal frame on the display and the voice outputting means is further added to the above-descried caption subject matter creating system, a greater advantage can be effected.

Also, if a preview means for previewing a textured letter on video of a corresponding frame is further added to the above-described caption subject matter creating system, it is possible to predict completion, which is convenient.

The above-described objective of the present invention is accomplished by a caption subject creating method for creating a text data synchronized with video by means of a computer, comprising steps of:

converting an image and voice recorded in a video tape into a digital data, allocating frame numbers to every frame of each video, and storing the digital data;

reproducing an image and voice based on the above-described stored data;

setting a frame that will be a beginning frame of a time code based on the reproduced image and voice, and storing a frame number of the above-described frame;

setting a starting frame that will be a starting point of a frame in which voice is to be textured and a terminal frame that will be a terminal point, and storing a frame number of the set starting frame and a frame number of the terminal number;

reproducing video and voice of a frame between the frame number of the starting frame and the frame number of the terminal frame;

inputting a text data corresponding to the reproduced voice;

calculating a time code of the above-described starting frame based on the frame number of the above-described starting frame and the frame number of the above-described beginning frame;

calculating a time code of the above-described terminal frame based on the frame number of the above-described terminal frame and the frame number of the above-described beginning frame; and

storing the above-described input text data, the time code of the above-described starting frame and the time code of the above-described terminal frame in association with each other.

In addition, if further having a step of repeatedly reproducing video and voice of a frame between the frame number of the starting frame and the frame number of the terminal frame on a display and a voice outputting means, the present invention can effect a greater advantage.

The objective of the present invention is accomplished by a storage medium in which a caption subject creating program for creating a text data synchronized with video by means of a computer is stored,

wherein the above-described caption subject creating program:

takes an image and voice recorded in a video tape in the computer, converts them into a digital data, and allocates frame numbers to every frame of each video, stores the data in the computer, and reproduces an image and voice based on the above-described stored data;

stores frame numbers of a beginning frame of a time code, a starting frame that will be a starting point of a frame in which voice is to be textured, and a terminal frame that will be a terminal point in the computer in response to a frame setting signal, and reproduces video and voice of a frame between the frame number of the starting frame and the frame number of the terminal frame;

makes the computer calculate a time code of the above-described starting frame based on the frame number of the above-described starting frame and the frame number of the above-described beginning frame, and calculate a time code of the above-described terminal frame based on the frame number of the above-described terminal frame and the frame number of the above-described beginning frame; and

makes the computer store the input text data, the time code of the above-described starting frame and the time code of the above-described terminal frame in association with each other.

In addition, if the above-described caption subject creating program makes the computer repeatedly reproduce video and voice of a frame between the frame number of the starting frame and the frame number of the terminal frame, a greater advantage can be obtained.

### BRIEF DESCRIPTION OF THE DRAWINGS

FIG. 1 is a conceptual view of a caption subject matter creating system in this embodiment;

FIG. 2 is a view showing one example of a display screen;

FIG. 3 is a view for explaining the present invention;

FIG. 4 is an operation flowchart of this embodiment;

FIG. 5 is a view showing one example of a display screen; and

FIG. 6 is a view showing one example of a display screen.

### DESCRIPTION OF THE EMBODIMENTS

An embodiment of the present invention will be explained.

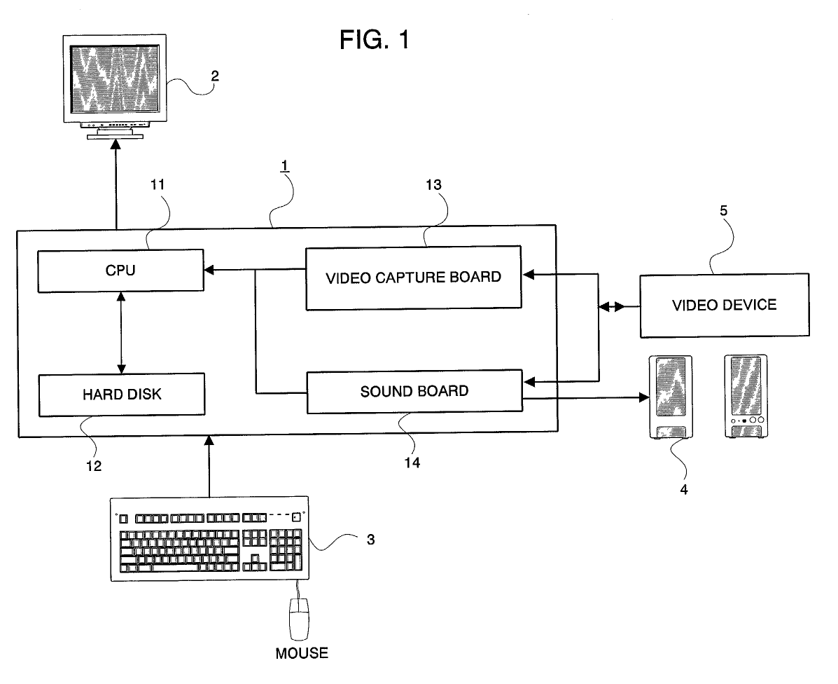

FIG. 1 is a conceptual view of a caption subject matter creating system in this embodiment.

In FIG. 1, a reference numeral 1 is a computer, and this computer 1 has a CPU 11, a hard disk 12, a video capture board 13, and a sound board 14. The video capture board 13 is a device for taking a video image output from a VTR device in the computer as a graphic data which the CPU 11 can process. The sound board 14 is for taking voice output from the VTR device as a digital data, and for outputting the voice from a speaker based on the digital data. In the hard disk 12, a caption subject matter creating program for making the CPU execute an operation mentioned later, an operation system (for example, Windows95, Windows98 and so forth), a graphic data taken in by the video capture board 13, and a sound data taken in by the sound board 14 are stored. The CPU 11 conducts control of the video capture board 13, the sound board 14 and other devices so as to make them conduct an operation mentioned later based on the program stored in the hard disk 12. Also, the computer 1 not only has functions for storage, calling, deletion and so forth, similar to various kinds of editor and word processor, but also, can register one caption screen as one page and stores it in a floppy disk (not shown), the hard disk 12 and so forth at a program unit.

A reference numeral 2 is a display, and is for displaying a graphic data (video) taken in the computer.

A reference numeral 3 is a key board including a mouse, and functions as a text input section.

A reference numeral 4 is a speaker, and is for outputting voice based on a voice data.

A reference numeral 5 is a video device for outputting video and voice recorded in a video tape.

Next, an operation in a system constructed as mentioned above will be explained. In addition, in this operation, the frame number of video to be taken in the computer 1 (video output from the video device 5) is assumed to be 30 frames per second in the basis of a usual NTSC method.

First, for the setting on a side of the computer 1, the frame number is set as 30 per second. And, the video from the video device 5 is taken in the computer 1 through the video capture board 13, and the voice from the video device 5 is taken in the computer 1 through the sound board 14.

The video and voice taken in the computer are converted into digital data, and become to be a file (for example, an AVI file) in which a video data and a voice data are associated with each other for every frame, and after a frame number for discriminating each frame is allocated thereto, the data are stored in the hard disk 12.

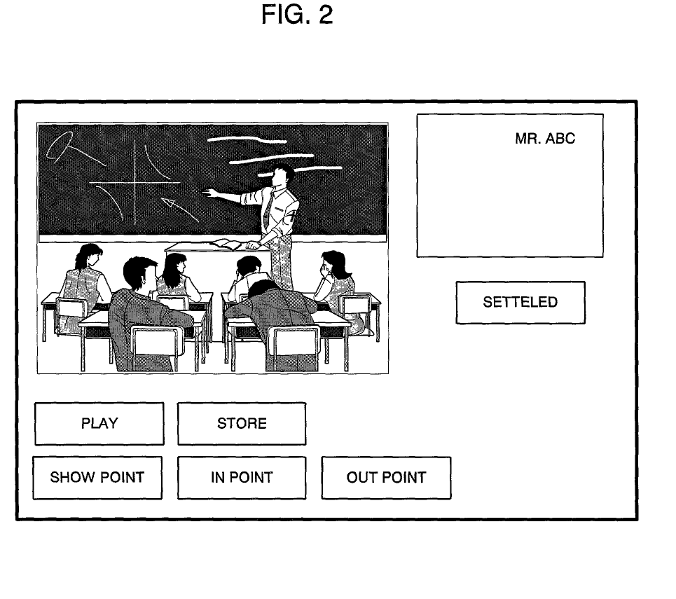

Next, the computer 1 reproduces video on the display 2 and reproduces voice by means of the speaker 4, based on the data stored in the hard disk 12. FIG. 2 is one example of a screen that is shown on the display 2 in this embodiment.

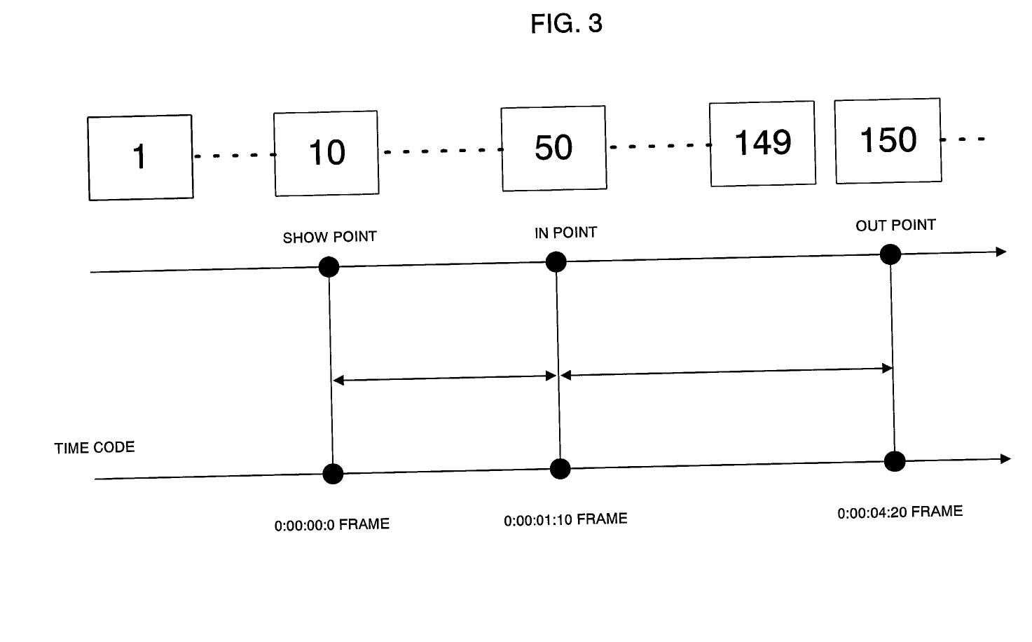

First, an operator designates a frame that will be a beginning frame (referred to as a SHOW point, hereinafter) of a time code. This designation is conducted by clicking a SHOW point setting button on a screen by means of a mouse at predetermined video timing while video that is shown is confirmed. And, the computer 1 detects the number of a frame that responds to this click. This aspect is shown in FIG. 3. In FIG. 3, a frame having a frame number 10 that was allocated on a computer side is set as a beginning frame of a time code.

Subsequently, a starting point (an IN point) of a frame to be textured and a terminal point (an OUT point) of a frame are set. For this setting, an operator clicks an IN point setting button on a screen by means of a mouse at timing of the first video to be textured while looking at video that is reproduced. Then, the computer 1 detects the number of a frame that has responded to this click. Similarly, an operator clicks an OUT point setting button on the screen by means of the mouse at timing of the last video to be textured while looking at video that is reproduced. Then, the computer 1 detects the number of a frame that has responded to this click. This aspect is shown in FIG. 3. In FIG. 3, it is shown that a frame number of an IN point is 50, and a frame number of an OUT point is 150.

Subsequently, video of a frame specified by the IN point and the OUT point (a frame between the IN point and the OUT point) is reproduced. An operator listens to voice that is reproduced while looking at the reproduced video, and the voice is textured. For example, if the voice reproduced from the frame number 50 to the frame number 150 is “Mr. ABC”, the operator listens to this voice, and inputs “Mr. ABC” by means of a key board. This input text is displayed on a text edit screen. In addition, letters that are shown on the text edit screen are displayed at a position corresponding to a letter insertion position of the video being reproduced. For example, in an example of FIG. 2, a display position of “Mr. ABC” in the text edit screen is a right upper position. This shows that a position at which video is actually inserted is a right upper position.

After the input is completed, the computer subtracts the frame number of the SHOW point from the frame number of the IN point. In other words, calculation, 50−10=40, is conducted. Similarly, the computer subtracts the frame number of the SHOW point from the frame number of the OUT point. In other words, calculation, 150−10=140, is conducted.

Here, numerals 40 and 140 are converted at one second for 30 frames to calculate a time code. In this case, a time code of the IN point is “0:00:00:10 frame”, and a time code of the OUT point is “0:00:04:20 frame”. And, the computer 1 stores a set of the time codes of the IN point and the OUT point and the textured “Mr. ABC” as a data.

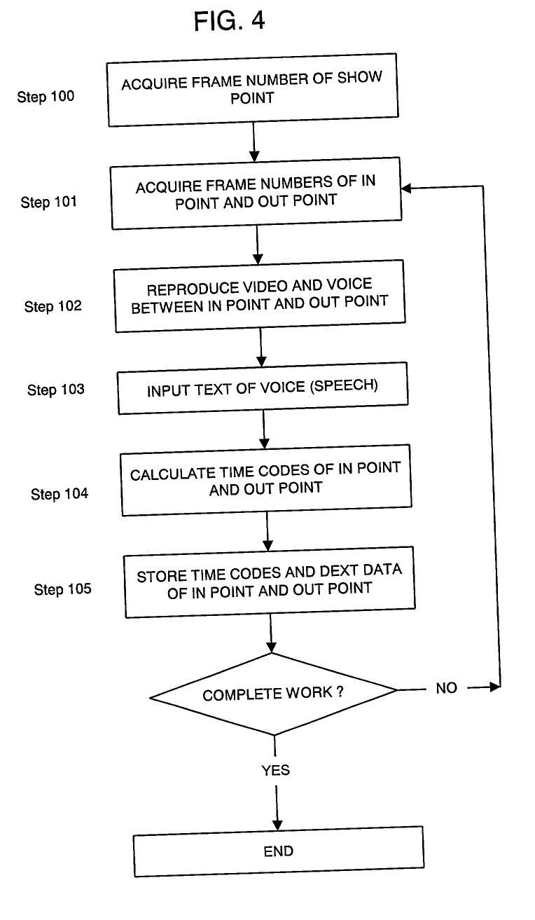

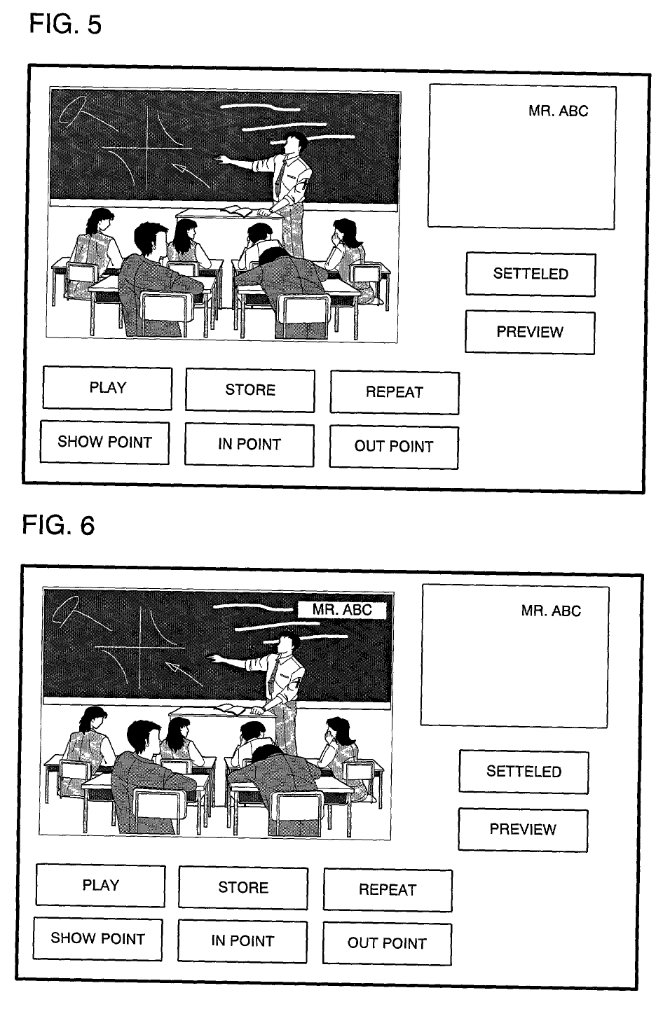

Further, this operation will be explained using a flowchart of FIG. 4.

First, a frame number (assumed to be Fs) of a SHOW point is obtained (STEP 100). Subsequently, an IN point and an OUT point of a scene including speech and so forth to be shown on the same screen are input, and their frame numbers (assumed to be Fi and Fo) are acquired (STEP 101). And, before the speech and so forth are textually input by means of a keyboard, the frame Fi to the frame Fo are reproduced (STEP 102). An operator inputs a text of voice while listening to the reproduced voice (STEP 103).

Numbers of frames Fi-Fs and Fo-Fs are obtained, and are converted into time codes (assumed to be Ti and To, respectively) at one second for 30 frames (STEP 104). Ti is stored as a text display beginning time code, To is stored as a text display terminating time code, and the input text is stored as a caption display text (STEP 105). STEP 101 to STEP 105 are repeated until a program ends.

According to this embodiment, it is possible to easily create a time code and a text data corresponding to this time code.

A second embodiment will be explained.

In the first embodiment, an arrangement is adopted, in which video and voice between an IN point and an OUT point are reproduced only one time, and however, when speech is textured, it is difficult to memorize whole speech including a technical term and a proper noun by listening to the speech only one time, and if it is possible to automatically and repeatedly listen to the speech many times, that is convenient.

Accordingly, the second embodiment is characterized in that, in addition to an arrangement of the first embodiment, a repeat section for repeatedly reproducing video and voice between an IN point and an OUT point is provided. This repeat section is embodied by means of the CPU 11. Since a data is a digital data and this data is taken in the hard disk 12, it is possible to repeat a head search infinite times in a short time. It is possible to realize texture in a short time rather than a conventional VTR that spends time for the head search.

Particularly, by clicking a REPEAT setting button on a drawing shown in FIG. 4 by means of a mouse, video and voice between an IN point and an OUT point that are presently set are repeatedly reproduced. During the repeat, the video is shown on a personal computer screen, and the voice is heard from a speaker. By means of the repeated reproduction, keyboard input is made much easily.

A third embodiment will be shown.

In recent years, due to improvement of performance of a voice recognition system, it has been possible to texture voice at a high probability, which is picked up by a microphone. Accordingly, the third embodiment is characterized in that, instead of a key board, a microphone 6 to which voice of an operator is input is used for an input section, and the voice picked up by the microphone 6 is textured by a voice recognition system.

In implementation of the third embodiment, it is the same as that of the first embodiment other than need of installing a voice recognition program in the hard disk 12 in advance.

For example, by combining it with the above-mentioned second embodiment, an operator speaks repeated voice again, and thereby, it is possible to conduct texture at a speed higher than that in keyboard input.

A fourth embodiment will be explained.

The fourth embodiment is characterized in that a preview section for inserting textured letters into a reproduced screen and previewing video into which the letters are inserted is provided.

By providing the preview section, it is possible to see video in which the letters are actually displayed, and to confirm an aspect of completion in advance. This preview section is embodied by means of the CPU 11, and as shown in FIG. 6, by clicking a preview setting button by a mouse, an input text is superimposed in a screen being shown. For example, in an example of FIG. 6, a display position in a text edit screen of “Mr. ABC” is a right upper position, and an insertion position on the screen being shown is also superimposed at a right upper position. In addition, an arrangement can be also adopted, in which a position at which a text is shown can be changed in accordance with instruction by an operator.

In the fourth embodiment, it is possible to simulate a position and a color of superimposition in a multiplexed text broadcasting tuner when being captioned on a display screen, so as to promptly understand a screen image of a caption broadcasting viewer during broadcasting.

As mentioned above, although each embodiment was explained, it is possible not only to implement each embodiment independently, but also to combine these embodiments with each other. For example, it is possible to combine the first embodiment with the second embodiment and the third embodiment.

According to the present invention, it is possible to create a caption broadcasting subject matter (a format based upon a caption broadcasting program exchange standard or a standard EIA 608 in the Unites States) rapidly and easily, based on a time code, a text and information of a display position.

What is claimed is:

1 A caption subject matter creating system comprising:
a memory for storing a digital data of an image and video;
a means for converting an image and voice recorded in a video tape into a digital data and storing said digital data in said memory, and allocating frame numbers to each of frames;
a display for displaying an image based on said digital data stored in said memory;
a voice outputting means for outputting voice based on said digital data stored in said memory;
a means for setting a frame that will be a beginning frame of a time code out of said frames, and storing a frame number of said frame;
a means for setting a starting frame that will be a starting point of a frame in which voice is to be textured and a terminal frame that will be a terminal point, and storing a frame number of said set starting frame and a frame number of said terminal number;
a means for displaying and outputting video and voice of a frame between said frame number of said starting frame and said frame number of said terminal frame on said display and said voice outputting means;
a means for, based on voice output from said voice outputting means, inputting a text data corresponding to said voice;
a calculator for calculating a time code of said starting frame based on said frame number of said starting frame and said frame number of said beginning frame;
a calculator for calculating a time code of said terminal frame based on said frame number of said terminal frame and said frame number of said beginning frame; and
a memory for storing said input text data, said time code of said starting frame and said time code of said terminal frame in association with each other.

2 A caption subject matter creating system according to claim 1, wherein a letter inputting means is a key board.

3 A caption subject matter creating system according to claim 1, wherein a letter inputting means is a voice recognition system.

4 A caption subject matter creating system according to claim 1, further comprising a repeat means for repeatedly displaying and outputting video and voice of a frame between said frame number of said starting frame and said frame number of said terminal frame on said display and said voice outputting means.

5 A caption subject matter creating system according to claim 1, further comprising a preview means for previewing a textured letter on video of a corresponding frame.

6 A caption subject matter creating system comprising:
a memory for storing a digital data of an image and video;
a means for converting an image and voice recorded in a video tape into a digital data and storing said digital data in said memory, and allocating frame numbers to each of frames;
a display for displaying an image based on said digital data stored in said memory;
a voice outputting means for outputting voice based on said digital data stored in said memory;
a means for setting a frame that will be a beginning frame of a time code out of said frames, and storing a frame number of said frame;
a means for setting a starting frame that will be a starting point of a frame in which voice is to be textured and a terminal frame that will be a terminal point, and storing a frame number of said set starting frame and a frame number of said terminal number;
a means for displaying and outputting video and voice of a frame between said frame number of said starting frame and said frame number of said terminal frame on said display and said voice outputting means;
a means for, based on voice output from said voice outputting means, inputting a text data corresponding to said voice;
a calculator for calculating a time code of said starting frame based on said frame number of said starting frame and said frame number of said beginning frame;
a calculator for calculating a time code of said terminal frame based on said frame number of said terminal frame and said frame number of said beginning frame;
a memory for storing said input text data, said time code of said starting frame and said time code of said terminal frame in association with each other;
a repeat means for repeatedly displaying and outputting video and voice of a frame between said frame number of said starting frame and said frame number of said terminal frame on said display and said voice outputting means; and
a preview means for previewing a textured letter on video of a corresponding frame.

7 A caption subject creating method for creating a text data synchronized with video by means of a computer, comprising steps of:
converting an image and voice recorded in a video tape into a digital data, allocating frame numbers to every frame of each video, and storing said digital data;
reproducing an image and voice based on said stored data;
setting a frame that will be a beginning frame of a time code based on said reproduced image and voice, and storing a frame number of said frame;
setting a starting frame that will be a starting point of a frame in which voice is to be textured and a terminal frame that will be a terminal point, and storing a frame number of said set starting frame and a frame number of said terminal number;
reproducing video and voice of a frame between said frame number of said starting frame and said frame number of said terminal frame;
inputting a text data corresponding to said reproduced voice;
calculating a time code of said starting frame based on said frame number of said starting frame and said frame number of said beginning frame;
calculating a time code of said terminal frame based on said frame number of said terminal frame and said frame number of said beginning frame; and
storing said input text data, said time code of said starting frame and said time code of said terminal frame in association with each other.

8 A caption subject creating method according to claim 7, further comprising a step of repeatedly reproducing video and voice of a frame between said frame number of said starting frame and said frame number of said terminal frame on a display and a voice outputting means.

9 A storage medium in which a caption subject creating program for creating a text data synchronized with video by means of a computer is stored,
wherein said caption subject creating program:
takes an image and voice recorded in a video tape in said computer, converts them into a digital data, and allocates frame numbers to every frame of each video, stores said data in said computer, and reproduces an image and voice based on said stored data;
stores frame numbers of a beginning frame of a time code, a starting frame that will be a starting point of a frame in which voice is to be textured, and a terminal frame that will be a terminal point in said computer in response to a frame setting signal, and reproduces video and voice of a frame between said frame number of said starting frame and said frame number of said terminal frame;
makes said computer calculate a time code of said starting frame based on said frame number of said starting frame and said frame number of said beginning frame, and calculate a time code of said terminal frame based on said frame number of said terminal frame and said frame number of said beginning frame; and
makes said computer store said input text data, said time code of said starting frame and said time code of said terminal frame in association with each other.

10 A storage medium in which a caption subject creating program is stored according to claim 9, wherein said caption subject creating program makes said computer repeatedly reproduce video and voice of a frame between said frame number of said starting frame and said frame number of said terminal frame.
